(19) United States
(12) Patent Application Publication
(10) Pub. No.: US 2011/0053720 A1
(43) Pub. Date: Mar. 3, 2011

(54) DUAL MODE CONTINUOUSLY VARIABLE TRANSMISSION

(76) Inventors: Myungkoo Kang, Busan (KR); Hyo Jeong Jeon, Busan (KR); Seungmo Kang, Busan (KR); Suejeong Kang, Busan (KR)

(21) Appl. No.: 12/832,750

(22) Filed: Jul. 8, 2010

(30) Foreign Application Priority Data
Sep. 1, 2009 (KR) 10-2009-0081995

(51) Int. Cl. F16H 7/00; F16H 61/662

(52) U.S. Cl. 474/148

(57) ABSTRACT

A dual mode continuously variable transmission (DMCVT), which can maintain advantages of a reducer operated in low-speed running mode and makes the diameter ratio of variable speed pulleys in high-speed transmission mode act as a reducer, thus improving durability and energy efficiency of the CVT. The DMCVT has a drive variable speed pulley mounted on an input shaft connected to an engine, a driven variable speed pulley mounted on an output shaft and receiving a rotatory force from the drive pulley through a belt, a drive shaft, first and second mode output gears mounted on the output shaft, first and second mode drive gears mounted on the drive shaft and gearing into the first and second mode output gears, respectively, and a synchro selector selectively engaging with a gear of one of the drive and driven shafts.

### BACKGROUND OF THE INVENTION

1. Field of the Invention

The present invention relates, in general, to continuously variable transmissions (CVT) and, more particularly, to a dual mode continuously variable transmission (DMCVT), which has a pair of variable speed pulleys and dual mode gear trains coupled to the pulleys so as to transmit engine power, thus preventing belt slip, friction heat, shift shock and hydraulic pressure loss which may be generated in a conventional CVT operating in high-speed transmission mode.

2. Description of the Related Art

A continuously variable transmission (CVT) is a transmission which can change steplessly through an almost infinite number of effective gear ratios within a predetermined range of transmission modes. Because the CVT contrasts with another type transmission, which can change through a limited number of effective gear ratios, the CVT is a so-called “stepless transmission”. The CVT can drive an engine at the most efficient rpm for a certain vehicle speed, and thus is thought of as a transmission having high economic efficiency.

FIG. 1 is a diagram schematically illustrating the construction and power transmission mechanism of a conventional belt-driven CVT. The power transmission mechanism of the belt-driven CVT 10 shown in FIG. 1 is realized by two variable speed pulleys 14 and 15 and a belt wrapped around the two pulleys 14 and 15 to transmit engine power. One pulley mounted on an input shaft 12, which is directly connected to an engine 11, is denoted as a drive variable speed pulley 14, while the other pulley, which is mounted on an output shaft 17, is coupled to the drive variable speed pulley 14 by a belt 16 and is denoted as a driven variable speed pulley 15.

In the operation of the conventional belt-driven CVT, the effective gear ratios can be changed by controlling the diameters of the pulleys. For example, in low-speed transmission mode, the diameter of the engine-side drive variable speed pulley 14 is changed to be smaller than the diameter of the wheel-side driven variable speed pulley 15, so that a large amount of torque can be transmitted to the wheel-side driven variable speed pulley 15. In high-speed transmission mode, the relationship of the diameters between the two pulleys 14 and 15 is changed to be opposed to the relationship formed in the low-speed transmission mode, thus realizing a high-speed rotation of wheels. The two variable speed pulleys are constructed such that the distance between opposite rims of each pulley can be controlled using hydraulic pressure. When the distance between the opposite rims of each pulley is reduced, the belt contact surface in each pulley, around which the belt 16 is wrapped, moves outwards in radial directions, thus increasing the effective diameter of the pulley. On the contrary, when the distance between the opposite rims of each pulley increases, the belt contact surface in the pulley moves inwards in radial directions, thus reducing the effective diameter of the pulley. Therefore, the desired gear ratio can be realized by controlling the distance between the opposite rims of each of the engine-side pulley and the wheel-side pulley such that the diameters of the two pulleys are increased or reduced in a reciprocal manner. Belts used in the conventional belt-driven transmissions are metal belts.

When driving or reversing from stop mode has been started, discs of a clutch 13 in the CVT, which have disengaged from each other, are brought into an engaged state. However, in another transmission mode, the clutch discs in the CVT are maintained in the engaged state, thus realizing less energy loss. Further, the CVT steplessly changes speed using the two variable speed pulleys and the belt having a predetermined fixed length, with the clutch discs maintained in an engaged state, so that the CVT does not generate shift shock and can steplessly change through an almost infinite number of effective gear ratios within a predetermined range of transmission modes, thus realizing the advantages of a soft power transmission effect. Due to the advantages of the CVT having no shift shock, the CVT has been used in a parallel hybrid car, which uses both an electric motor and an engine as an alternate power source, in recent years.

In the past, the CVT was rated as an ideal transmission theoretically having high energy efficiency. However, the CVT has small allowable limits for torques of the variable speed pulleys and the belt, so that the CVT has been mainly adapted to small-sized cars. This is because of the fact that, when the CVT is used in a car having high engine power, the CVT can not effectively endure the high engine power. Further, the CVT has a small allowable limit for the torque related to belt tension and easily generates heat due to slipping and friction between the belt and the pulleys during the high speed running mode of a car, thereby resulting in energy loss and a reduction in the expected lifespan of the belt, and also it causes additional energy loss due to a hydraulic controller used for driving the variable speed pulleys. Therefore, the applications of CVTs are limited. Although CVTs have higher mileage and energy efficiency in comparison to conventional automatic transmissions, the energy efficiency of the CVT is lower than that of conventional manual transmissions.

For example, the NEW SM3, manufactured by Renault Samsung using a CVT, has a mileage of 15.0 km/f and achieves first grade mileage which is higher than that of models using conventional automatic transmissions. However, this mileage of the NEW SM3 is still lower than the mileage of 16.3 km/l of models using conventional manual transmissions.

Although the CVT realizes soft acceleration and suits frequent speed change and low-speed operation of a car in the center of a city, the CVT is problematic in that the mileage thereof is lower than that of another type of transmission that uses gears in the case of steady operation at high speed, for example, in the case of being operated on a highway on which cars may maintain a high speed not lower than 100 km/h steadily, realized by a transmission mode of 5 or more stages.

Although the CVT had been in fashion due to the advantages of volume, price and durability for a while in the past, the applications of the CVT are limited to small-sized cars due to the above-mentioned problems. Nissan and Audi propose a CVT, which somewhat overcomes the problems of the conventional CVTs and can be used in cars with large amounts of exhaust. In recent years, as parallel hybrid cars are proposed, the CVT is drawing attention. One important improvement in the CVT is an improvement in the durability of the belt. Although the CVT is problematic in that it is not suited for high-speed operation and results in quick abrasion of the belt, the CVT luckily is suited to operation in the center of a city, in which it is required to frequently change the speed in low-speed transmission mode, such as a transmission mode of 1-, 2- or 3-stage, and suits low-speed operation, so that the CVT may have an effect on improvements in mileage.

In recent years, the CVT has been improved in volume, price and durability and Nissan uses the CVT in 4-wheel drive cars, such as Murano and Rogue. The mileage of the CVT is lower than that of conventional manual transmissions, but is higher than that of conventional automatic transmissions. Further, the CVT has soft, excellent acceleration performance and suits frequent speed changes in low stage transmission modes and operation in the center of a city. However, in the case of high-speed operation, the expected lifespan of the belt in the CVT is reduced due to slipping and friction between the belt and pulleys and the energy efficiency of the CVT is reduced.

In recent years, as hybrid cars have been drawing attention, the CVT which does not generate shift shock or shift lag also draws attention. In existing parallel hybrid cars, there inevitably exists a common drive range, in which the engine and the motor are commonly driven, within a low-speed range and an acceleration range due to characteristics of the parallel hybrid car. In the common drive range of parallel hybrid cars, the drive motor and the engine aid each other, so that it is required to synchronize rpms between the motor and the engine. The CVT, which does not generate shift shock, has advantages in view of the synchronization of rpm. In a conventional transmission, when a shift gear is changed from a low stage to a high stage so as to increase the running speed of a car, there inevitably exist both shift shock and shift lag in the transmission. Described in detail, when the conventional shift gear is changed to a high stage, the operating speed of a car is stepwisely increased by disengaging the clutch discs from each other, reducing the engine rpm by stopping the acceleration of the engine and synchronizing the engine rpm with the rpm of high stage gears, engaging the engine with the high stage gears, reengaging the clutch discs with each other, and increasing the engine rpms by reaccelerating the engine. Unlike the conventional transmission, when a car is accelerated, the CVT can gradually increase the running speed of the car by continuously changing the diameter ratio between the variable speed pulleys using a hydraulic controller to a gear ratio of high stage gears within a range allowed by an engine torque at a predetermined engine rpm without executing the complex steps of the conventional transmission. Accordingly, the CVT can achieve easy synchronization of the drive motor rpm with the engine rpm without generating shift shock or shift lag. Although the parallel hybrid cars may use conventional manual or automatic transmissions, it is more efficient to use CVTs in the parallel hybrid cars in view of technical efficiency and energy efficiency.

In a parallel hybrid car, the synchronization of the motor rpm with the engine rpm is an important factor in view of energy efficiency. When both the engine and the motor are driven at the same time at respective rpm, wherein the engine rpm is higher than the motor rpm or the motor rpm is higher than the engine rpm, it is necessary to synchronize the motor rpm with the engine rpm because the engine and the motor are installed on a common shaft. When the engine rpm is equal to the motor rpm, the engine and the motor aid each other and form a synergy wherein the engine output power and the torque increase. However, when there is a difference in rpms between the engine and the motor, one part having lower rpm acts as a load on the other part having higher rpm. This is because of the fact that the CVT does not have the function of a free wheel which has been used in conventional tandem bicycles. It is necessary for the CVT to be free from the free wheel function because the drive motor in an exclusive engine drive mode or an engine brake mode can effectively execute a second function thereof in which the motor can act as an electric power generator. The output power of the engine is typically greater than that of the motor, so that the motor typically aids the operation of the engine under the electric and electronic control of a computer. However, when the motor rpm in the above state is low, the motor may not efficiently aid the engine operation, but imposes a load on the engine. When the motor rpm in the above state is exceedingly high, the motor undesirably causes a waste of energy to reduce energy efficiency although the motor may aid a little increase in the engine rpm. Thus, it is required to synchronize the intrinsic motor rpm with the intrinsic engine rpm in an effort to optimally increase the torque and realize improvements in energy efficiency. When a car accelerates, the engine rpm increases. In the above state, the motor rpm must increase to be slightly higher than the engine rpm and the motor in the above state can aid an increase in the engine rpm, thus realizing efficient acceleration and improvements in energy efficiency.

When a CVT is used in a hybrid car, the CVT may be advantageous in that, when the motor rpm is synchronized with a predetermined engine rpm and forms a synergy, the gear ratio of the pulleys can be changed to a high stage gear ratio using surplus torque. Further, the CVT used in a parallel hybrid car may be advantageous in that it can realize high mileage in the case of running in the center of a city. However, in the case of constant running at a high speed, the mileage of the parallel hybrid car using the CVT is still lower than that of a car using a conventional transmission. When it is required to maintain constant operation at a high speed for a lengthy period of time, the parallel hybrid car uses the engine as the power source. In the above state, the motor is not used as the power source for the car, but functions as an electric power generator for charging the battery. However, when battery charging has been completed, the function of the motor as the generator is meaningless, and the presence of the motor undesirably impose a load on the car.

As described above, although the CVT realizes high mileage and high running performance in low-speed transmission mode, the CVT is problematic in high-speed transmission mode. Described in detail, in low-speed transmission mode, the diameter of the drive variable speed pulley is smaller than the diameter of the driven variable speed pulley and the engine rpm reduces, so that the belt rotates at a low speed. Accordingly, the belt does not slip over the pulleys, thus reducing power loss and reducing friction heat generated between the belt and the pulleys. However, in high-speed transmission mode, the diameter of the drive variable speed pulley is smaller than the diameter of the driven variable speed pulley and the engine rpm increases, so that the linear velocity of the belt rotating around the pulleys exceedingly increases. When the linear velocity of the belt increases exceedingly as described above, the belt frequently slips over the belt contact surfaces of the pulleys, thus resulting in power loss and generating friction heat caused by friction between the belt and the pulleys, thereby deteriorating energy efficiency. This also has serious negative effects on the expected lifespan of the belt and the pulleys.

Therefore, it is required to propose a CVT, which can realize the advantages of the conventional CVT in low-speed transmission mode, can reliably execute a speed changing operation in high-speed transmission mode, thus having excellent energy efficiency, and minimizes negative effects on the belt and the pulleys due to high-speed rotation, thus realizing improved durability of the belt and the pulleys.

### SUMMARY OF THE INVENTION

Accordingly, the present invention has been made keeping in mind the above problems occurring in a high-speed transmission mode of a conventional CVT and the present invention is intended to propose a dual mode continuously variable transmission (DMCVT), which can control the input-side variable speed pulley such that the diameter of the pulley in a high-speed transmission mode does not increase over a predetermined range, and which can efficiently output rotatory force within a desired range, thus preventing power loss caused by belt slip, preventing a reduction in durability of the belt and the pulleys and energy loss caused by a quick increase in friction heat generated between the belt and the pulleys, and preventing breakage of important parts related to belt driving.

In order to achieve the above object, according to one aspect of the present invention, there is provided a dual mode continuously variable transmission comprising: a rotatable drive variable speed pulley P1 mounted on a rotatable input shaft IS connected to an engine; a rotatable driven variable speed pulley P2 mounted to an output shaft OS arranged in parallel to the input shaft IS, thus receiving a rotatory force from the drive variable speed pulley P1 through a belt B; a drive shaft DS arranged in back of the input shaft IS such that the drive shaft DS is in parallel to the output shaft OS; a first mode output gear LG1 and a second mode output gear HG1 mounted on the output shaft OS; a first mode drive gear LG2 and a second mode drive gear HG2 mounted on the drive shaft DS and gearing into the first mode output gear LG1 and the second mode output gear HG1, respectively; and a synchro selector S slidably mounted on at least one of the drive shaft DS and the output shaft OS and selectively engaging with gears of the shaft on which the synchro selector S is mounted.

In an embodiment, a wet type or dry type friction clutch may be coupled to the input shaft IS in front of the drive variable speed pulley P1, thus controlling the power output from the engine.

In an embodiment, the gear ratio between the output gear LG1 and the drive gear LG2 for the first mode and the gear ratio between the output gear HG1 and the drive gear HG2 for the second mode may be set to be different from each other.

In an embodiment, the gear ratio between the output gear LG1 and the drive gear LG2 for the first mode may be set to 1:1, and the gear ratio between the output gear HG1 and the drive gear HG2 for the second mode may be set to be within a range of 2˜1:1.

The dual mode continuously variable transmission (DMCVT) of the present invention solves the problem of a performance reduction, which may be experienced in a high-speed transmission mode of a conventional CVT. Described in detail, in a low-speed transmission mode of the conventional CVT, wherein the diameter ratio of two variable speed pulleys is set to a level suitable for the function as a reducer, the conventional CVT provides excellent mileage and excellent running performance. However, in a high-speed transmission mode of the conventional CVT, wherein the diameter ratio of the two variable speed pulleys is set to a level suitable for the function as an accelerator, the rotatory speed of the belt exceedingly increases, thus generating slip of the belt over the pulleys and producing friction heat between the belt and the pulleys, thereby deteriorating durability of related parts and causing energy loss. However, the present invention is configured such that the diameter ratio between the pulleys in a high-speed transmission mode can be set to a level suitable for the function as a reducer, so that the present invention can solve the above-mentioned problems of the conventional CVT.

In other words, in a low-speed transmission mode, the first mode having a gear ratio of 1:1 is selected, while, in a high-speed transmission mode, the second mode having a gear ratio of 2˜1:1 is selected prior to output of rpm, so that it is possible to realize output of desired rpm without exceedingly increasing the diameter of the input-side variable speed pulley. Accordingly, the advantages, expected from the conventional CVT in a low-speed transmission mode, can be achieved by the CVT of the present invention in a high-speed transmission mode. Therefore, the CVT of the present invention can realize economic efficiency and excellent running performance.

Further, in the CVT of the present invention, the diameter ratio between the two variable speed pulleys for realizing high speed output power can be maintained at the same level as that of a typical reducer, so that the variable sizes of the variable speed pulleys can be reduced compared to a conventional CVT. The reduction in the size of the pulleys provides advantages of reducing the manufacturing cost of the transmission, reducing the volume and improving the mileage.

Due to the above-mentioned advantages of the present invention, i.e. improvements in the durability of the belt, the variable speed pulleys, the hydraulic controller and the parts related to them and an improvement in energy efficiency, the CVT can be adapted to a large-sized car having a large amount of exhaust in addition to a small-sized car, so that the advantages will contribute to a considerable enlargement of the CVT applications.

Further, when the present invention is adapted to a parallel hybrid car which has been drawing attention in recent years, the CVT can function as a transmission having high efficiency, so that the present invention can realize improvements in the durability and energy efficiency of the parallel hybrid car and can contribute to the considerable development of the related industries.

In the present invention, a torque converter instead of a dry type or wet type frictional clutch may be mounted on the input shaft IS at a location in front of the drive variable speed pulley P1. In the above state, a wet type or dry type friction clutch may be mounted on the output shaft OS at a location in back of the driven variable speed pulley P2, thus controlling the power transmitted from the input shaft IS.

### BRIEF DESCRIPTION OF THE DRAWINGS

FIG. 1 is a diagram schematically illustrating the construction and power transmission mechanism of a conventional belt-driven CVT;

FIG. 2 through FIG. 4 are diagrams schematically illustrating the construction and power transmission mechanism of a CVT according to a first embodiment of the present invention;

FIG. 5 is a diagram schematically illustrating the construction and power transmission mechanism of a CVT according to a second embodiment of the present invention;

FIG. 6 is a diagram schematically illustrating the construction and power transmission mechanism of a CVT according to a third embodiment of the present invention;

FIG. 7 is a diagram schematically illustrating the construction and power transmission mechanism of a CVT according to a fourth embodiment of the present invention; and

FIG. 8 is a diagram schematically illustrating the construction and power transmission mechanism of a CVT according to a fifth embodiment of the present invention.

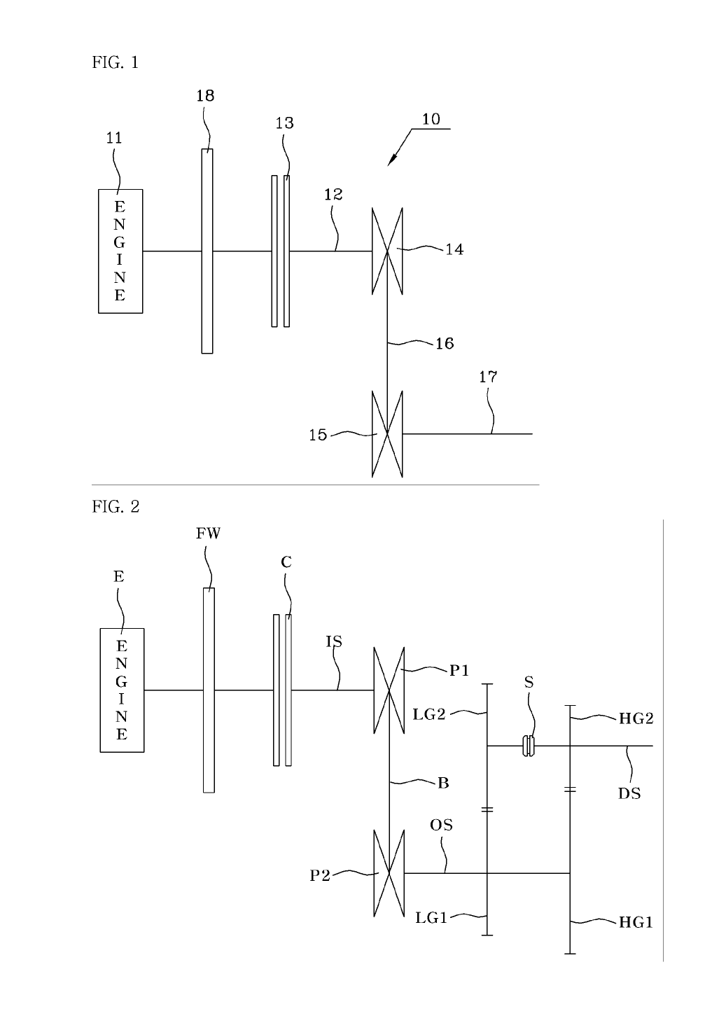

### DETAILED DESCRIPTION OF THE INVENTION

Hereinbelow, the construction and operation theory of the present invention will be described in detail with reference to the accompanying drawings.

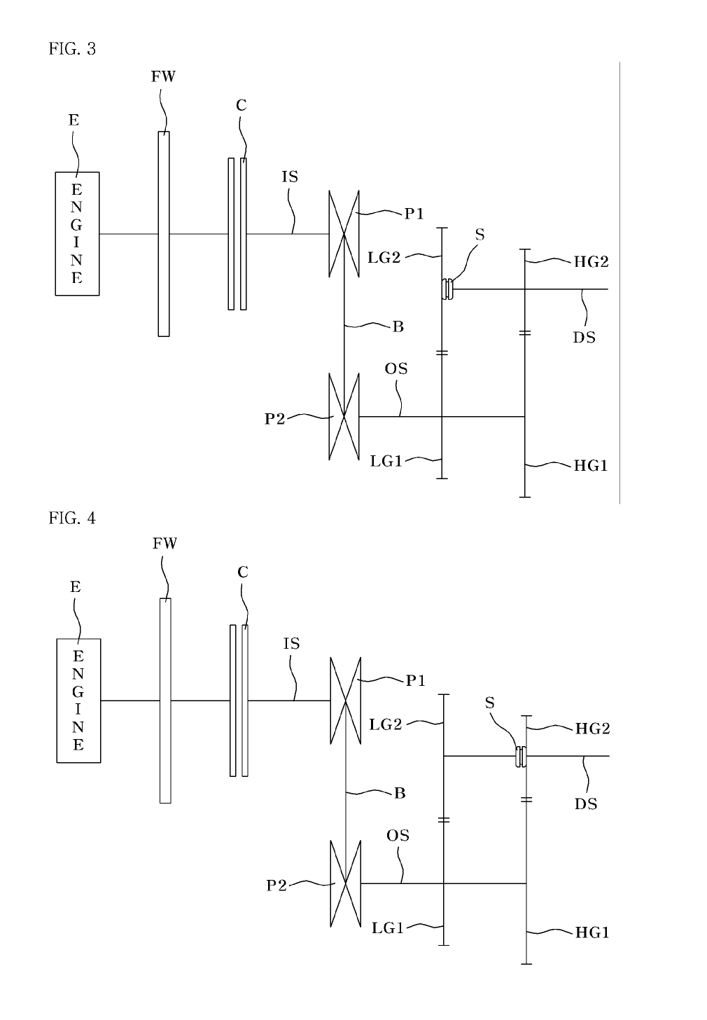

FIG. 2 through FIG. 4 are diagrams schematically illustrating the construction and power transmission mechanism of a continuously variable transmission (CVT) according to a first embodiment of the present invention. Like a conventional CVT, the dual mode continuously variable transmission (DMCVT) according to the present invention comprises two pulleys P1 and P2 and a belt B, with gears LG1, LG2, HG1 and HG2 coupled to the pulleys for changing through the gear ratios between dual modes.

A clutch C for controlling speed change operation of the CVT is provided on an input shaft IS which directly receives a rotatory force from an engine E, a drive variable speed pulley P1 is mounted on the input shaft, and a driven variable speed pulley P2 is mounted on an output shaft OS. The power transmission from the drive variable speed pulley P1 to the driven variable speed pulley P2 is realized by the belt B. It is preferred that the belt B be a metal belt. In the drawing, the reference character FW denotes a flywheel. Further, the clutch C may be selected from conventional dry type clutches, but the type of the clutch C is not limited to the dry type clutches. In other words, the clutch C may be selected from wet type clutches or torque converters generally used in conventional automatic transmissions. In the case of a torque converter used as the clutch C, the structure of the torque converter will be described in the description for the fourth embodiment of the present invention.

Additional gears are mounted on the output shaft OS connected to the driven variable speed pulley P2. In other words, a first mode output gear LG1 is arranged at a front position and a second mode output gear HG1 is arranged at a rear position.

A drive shaft DS is arranged at a location in back of the input shaft IS such that the drive shaft DS is in parallel to the output shaft OS. The drive shaft DS is coupled to wheels of a car through a differential gear (not shown). Both a first mode drive gear LG2 and a second mode drive gear HG2 are mounted on the drive shaft DS and gear into the first mode output gear LG1 and the second mode output gear HG1, respectively.

A synchro selector S is slidably mounted on the drive shaft DS at a location between the first mode drive gear LG2 and the second mode drive gear HG2 and selectively engages with one of the two mode drive gears LG2 and HG2 so as to transmit power. The synchro selector S functions as a clutch and is coupled to an actuator (not shown), and is controlled by an electronic control unit.

As mentioned above, the synchro selector S may be provided on the output shaft OS unlike the first embodiment, and the provision of the synchro selector S on the output shaft OS will be described later herein.

The drive variable speed pulley P1 and the driven variable speed pulley P2 are provided with respective hydraulic pressure chambers (not shown). The hydraulic pressures in respective hydraulic pressure chambers are controlled by a hydraulic controller (not shown), which controls the distance between opposite rims of each variable speed pulley, thereby controlling the pulley diameters. In other words, the hydraulic controller controls hydraulic pressures in respective hydraulic pressure chambers in consideration of both the rotatory speed and the transmission ratio of the drive variable speed pulley P1, which functions as an input-side pulley, thus changing the diameter of the variable speed pulley and changing the transmission gear ratio.

The continuously variable transmission (CVT) is characterized in that it responds slowly to initial acceleration. The slow response to the initial acceleration causes a disadvantage of the CVT and, at the same time, also realizes an advantage of the CVT. When a car runs at low speeds while frequently changing speed in the center of a city, the CVT can increase mileage and can advantageously realize soft, constant running. This is the intrinsic characteristic of the CVT, which is caused by the fact that the CVT can realize acceleration by changing the diameter ratio of the variable speed pulleys for a constant engine rpm. In a conventional gear transmission, acceleration is realized sequentially by initially increasing the engine rpm at a predetermined gear ratio, disengaging the clutch discs from each other, reducing the engine rpm, changing the gear to a higher stage gear and finally increasing the engine rpm. However, the CVT realizes the acceleration by smoothly controlling the diameter ratio of the two variable speed pulleys without reducing the engine rpm.

The slow initial response of the CVT to the acceleration is caused by the fact the speed increases as a result of changing the diameter ratio of the variable speed pulleys for a constant engine rpm, as described above. The slow initial response of the CVT to acceleration is also caused by the fact that the moving speed of the belt B wrapped around the variable speed pulley of the input shaft, which is the drive variable speed pulley P1, in high-speed running increases and becomes high. When slipping and friction repeatedly occur between the belt and the variable speed pulleys, friction heat and shift shock are produced and result in damage to the belt and the pulleys, thus reducing the expected lifespan of the belt and the pulleys and reducing energy efficiency. Further, when the drive variable speed pulley P1, which has a large diameter and generates a high load, rotates at a high speed, the hydraulic controller for maintaining the large diameter of the drive pulley P1 is overloaded.

The above-mentioned problems of the CVT experienced in the case of high-speed running are caused by the fact that the important power coupling devices in the CVT comprise the belt and the variable speed pulleys instead of gears. In a 1-stage gear range, wherein the gear ratio between the input-side and output-side gears is set to about 1:4, both the belt and the variable speed pulleys can effectively resist 5,000 rpm, which is the input-side engine rpm. However, in a 6-stage gear range, wherein the gear ratio between the input-side and output-side gears is set to about 1:0.7, the belt and the variable speed pulleys may be overloaded. Due to high-speed rotation of the drive variable speed pulley P1 having increased diameter, the torque load on the belt B increases and the moving speed of the belt B, which is wrapped around and rotates over the variable speed pulleys P1 and P2, increases several times, thus generating shift shock and friction heat due to slipping and friction between the belt and the pulleys, thereby reducing the expected lifespan of both the belt and the pulleys.

Transmissions are typically classified into two types, which are a reducer configured to increase torque by reducing rpms and an accelerator configured to increase rpms for realizing high-speed running even when torque is reduced. A transmission for cars has these two functions and is configured to act as a reducer in low-speed running and as an accelerator in high-speed running. Typically, in a manual transmission having six stages, the transmission mode of 4-stage has a gear ratio of 1:1, so that the transmission functions as a reduction transmission within a range from 1-stage to 3-stage and as an acceleration transmission within a range from 5-stage to 6-stage. In other words, in low stages, where the transmission acts as a reducer, the output-side engine rpm becomes lower compared to the input-side engine rpm and the torque increases to become higher than the engine torque. In high stages, in which the transmission acts as an accelerator, the output-side engine rpm becomes higher compared to the engine rpm, the running speed increases and the torque reduces to be lower than the engine torque. Accordingly, in high stages, the belt, the variable speed pulleys and the engine are overloaded. In the case of driving from stop mode, the static friction load caused by the weight of a car reaches the maximum load, so that it is necessary to set the gears to a low stage so as to let the transmission act as a reducer. In the above state, the load imposed on both the engine and the belt can be reduced and the engine can realize the desired drive mode without sudden stopping. When the diameter ratio of the pulleys has been already set to a high stage in the driving from stop mode, the belt and/or pulleys may not effectively endure the static friction load and may be broken or may cause the engine to stop. When the car starts and is put in drive mode and the running speed of the car increases, dynamic inertia increases and the load on both the engine and the belt reduces, so that the shift to a high stage can be realized and the transmission can acts as an accelerator, thus increasing the running speed of the car. In other words, the CVT can control the gear ratio from a low stage gear ratio to a high stage gear ratio within both a load endurable by the engine, the pulleys and the belt and the allowable limit of the torque, so that the CVT can change its function from a reducer to an accelerator and can increase the running speed of the car.

In the CVT, the two variable speed pulleys are fixed to respective shafts and the belt has a fixed length. Therefore, in the CVT, in order to apply the desired tension to the belt having the fixed length and to reliably transmit the engine power to the drive shaft, it is necessary to control the diameters of the two pulleys as follows. In a low stage mode of the CVT, the diameter of the input-side variable speed pulley (drive variable speed pulley) must be reduced, while the diameter of the output-side variable speed pulley (driven variable speed pulley) must increase. In a high stage mode of the CVT, the diameter of the input-side variable speed pulley must increase, while the diameter of the output-side variable speed pulley must be reduced. For example, at 5,000 rpm of the input shaft, the diameter of the input-side variable speed pulley in a high stage mode increases, so that the moving speed of the belt moved by the input-side variable speed pulley in the above stage increases so high compared to a low stage mode in which the diameter of the input-side variable speed pulley is reduced. Accordingly, although the high-speed rotating belt can endure a torque load imposed thereon, the moving speed of the belt, which moves around the variable speed pulleys rotating at high speeds due to the high-speed rotation of the input-side pulley having a large diameter, increases several times, thus generating slipping and friction heat between the belt and the pulleys, thereby causing energy loss and seriously deteriorating the durability of both the belt and the variable speed pulleys.

In the dual mode continuously variable transmission (DMCVT) according to the present invention as shown in FIG. 2, a drive shaft DS in addition to the output shaft OS is provided and dual mode gears LG1, LG2, HG1 and HG2 are mounted on the drive shaft DS in an effort to overcome the problem experienced in the high stage modes.

The mechanism of the dual mode continuously variable transmission (DMCVT) according to the present invention will be described herein below.

When the variable transmission ratio between the drive variable speed pulley P1 and the driven variable speed pulley P2 is set to within a range of 1:4 to 1:0.7, two sets of gears are arranged at locations between the output shaft OS and the drive shaft DS, thus being selected by the synchro selector S. For example, each set of gears may comprise gear sets having gear ratios set to 1:1 and 2:1. In other words, as shown in the drawing, the gear ratio between the first mode output gear LG1 and the first mode drive gear LG2 is set to 1:1, and the gear ratio between the second mode output gear HG1 and the second mode drive gear HG2 is set to 2:1. When the mechanism of DMCVT is constructed as described above, the CVT can be operated in dual modes that are a low-speed midtown running mode and a high-speed running mode. Described in detail, the CVT can be operated in two modes: a low-speed transmission mode which is the first mode CVT-1 and a high-speed transmission mode which is the second mode CVT-2. In the case of a parallel hybrid car using the DMCVT, the first mode is a mode in which both the engine and the electric motor are operated at the same time, while the second mode is a high-speed transmission mode in which only the engine is operated. In the above state, the selection of gears for the first mode or the second mode can be executed by the synchro selector S.

Therefore, in driving from stop mode, the synchro selector S engages with the first mode gears having a gear ratio of 1:1. Driving from stop mode starts at a diameter ratio of 1:4 between the two variable speed pulleys and the driven variable speed pulley P2 is continuously coupled to the first mode gears having the gear ratio of 1:1 until the mode has been changed to a predetermined stage mode, for example, 3-stage mode or 4-stage mode. Thereafter, when the running speed of the car somewhat increases to nearly achieve the diameter ratio of 1:1 between the two variable speed pulleys corresponding to a 4-stage mode of a conventional manual transmission, the synchro selector S synchronizes the second mode gears having a gear ratio of 2:1, so that the engine power is transmitted to the driven variable speed pulley P2. In the above state, because the gear ratio in the second mode is 2:1, the desired rpm can be output to the drive shaft DS without increasing the diameter of the drive variable speed pulley P1 or reducing the diameter of the driven variable speed pulley P2 in order to achieve high-speed operation. In other words, when the second mode having the gear ratio of 2:1 is selected with the diameter ratio of 1:1 between the drive variable speed pulley P1 and the driven variable speed pulley P2, the transmission of the rotatory force of the drive variable speed pulley P1 to the driven variable speed pulley P2 is maintained and the second mode output gear HG1 mounted on the same output shaft OS as that of the driven variable speed pulley P2 receives the power with the same rpm. The rotatory force of the second mode output gear HG1 is transmitted to the second mode drive gear HG2 mounted on the drive shaft DS. In the above state, the gear ratio of the second mode gears is 2:1, so that the rpm of the second mode drive gear HG2 becomes increased twofold. Accordingly, high speed output power for realizing the high-speed operation can be achieved without reversing the diameter ratio between the drive variable speed pulley P1 and the driven variable speed pulley P2.

In the above state, when the diameter ratio between the drive and driven variable speed pulleys is reduced to 1:2, which is the same ratio as that of a reducer, the gear ratio between the input shaft and the drive shaft becomes 1:1. When the diameter ratio between the two variable speed pulleys further is reduced to 1:1.5, the gear ratio between the input shaft and the drive shaft becomes 1:0.75, so that a high-speed running mode can be achieved without increasing the diameter of the drive variable speed pulley or increasing the linear velocity of the belt. Therefore, the belt, which rotates around the two variable speed pulleys, can transmit the rpm acceleration effect, which can be expected from the diameter ratio of 1:0.75 between the variable speed pulleys, to the drive shaft at a moving speed achieved by the diameter ratio of 1:1.5 between the variable speed pulleys. The first mode having both a gear ratio of 1:1 and a diameter ratio of 1:0.75 between the variable speed pulleys and the second mode having both a gear ratio of 2:1 and a diameter ratio of 1:1.5 between the variable speed pulleys impose the same tension load on the belt. However, there is a difference of several folds in the moving speed of the belt formed by the drive variable speed pulley P1, which is the input-side pulley, between the first and second modes. Even when the moving speed of the belt is reduced, the rotatory speed of the drive shaft DS increases due to the gear ratio of 2:1 in the output shaft OS. Accordingly, the present invention can prevent both the generation of shift shock and a quick increase in the friction heat, which may be caused by both an increase in the diameter of the drive variable speed pulley and high speed rotation of the belt.

The coupling of the synchro selector S between the first mode and the second mode may be appropriately achieved by an additional clutch control computer (not shown). That is, the clutch control computer detects the rotatory speed of the engine, the running speed of the car, an accelerator pedal opening ratio signal and a selector level position signal, and drives the synchro selector S at an optimal timing.

The dual mode continuously variable transmission (DMCVT) having the above-mentioned construction can be effectively adapted to a parallel hybrid car. In a parallel hybrid car, the drive motor is driven only in a predetermined mode, such as being driven from stop mode or low-speed acceleration mode. In other words, in high-speed transmission mode of the parallel hybrid car, only the engine functions as a drive power source. In the parallel hybrid car, the engine and the drive motor can commonly output drive power within a predetermined range of stages corresponding of 3-stage or 4-stage of a conventional manual transmission, so that, when the timing to control the gear ratio and the timing to control the synchro selector S are preset to predetermined respective values, it is possible to avoid operating the synchro selector S within a range in which the motor is driven. In other words, in a range of first mode CVT-1, both the engine and the motor can be driven at the same time.

In the CVT, the diameter ratio between the variable speed pulleys can be controlled by the hydraulic controller. This will now be described in detail. The hydraulic control valve system of the hydraulic controller is connected to the hydraulic pressure chambers (not shown) of the drive and driven variable speed pulleys, so that the speed change can be achieved by controlling the diameters of the two variable speed pulleys in consideration of the opening ratio of the accelerator pedal, the transmission ratio and the rotatory speed of the input shaft pulley. The speed change operation achieved using hydraulic pressure results in the additional consumption of engine energy, thus reducing the energy efficiency of the transmission and reducing mileage. Accordingly, when the control mechanism for the variable speed pulleys and the clutch is changed from a hydraulic mechanism to a motored mechanism in the same manner as that of a power steering wheel, in which the control mechanism is changed from a hydraulic mechanism to a motor mechanism, the energy efficiency of the engine will be highly improved.

In response to the development of computer added control techniques, many machines, which have been manually controlled, have become automated. In recent years, an automated manual sequential transmission (AMST), which is realized by combination of a manual transmission with a computer added control technique and can provide excellent mileage, has been proposed. Peugeot 308MCP is an example of a model using AMST and provides 19.8 km/l mileage. Further, in a transmission, the hydraulic pump or the electric pump may be controlled using a computer. Described in detail, when the mode in a transmission is changed from a first mode having a gear ratio of 1:1 to a second mode having a gear ratio of 2:1, the clutch discs disengage from each other by either the hydraulic pump or the electric motor and the synchro selector S engages with the second mode gears and, thereafter, the clutch discs engage with each other again, thus transmitting the rotatory force. However, when the variable speed pulleys are controlled using a computer while monitoring rpm of the engine E, rpm of the input shaft IS, rpm of the output shaft OS and rpm of the drive shaft DS, the synchro selector S can disengage from gears in a state in which the clutch discs continuously engage with each other and synchronizes the rpm prior to being brought into engagement with next mode gears. This reduces shift shock and realizes an improvement in energy efficiency.

In the first mode CVT-1 and the second mode CVT-2, the gear ratio between the output gear and the drive gear must be determined based on both the engine output power and the weight of a car. The determination of the gear ratio is an important factor, which determines the performance and size of the transmission. Further, it is preferred that a range in which the engine and the motor of a parallel hybrid car are driven at the same time be included within the first mode of the CVT. Further, in view of the durability of the CVT, it is preferred that the diameters of the variable speed pulleys be set such that the diameter of the input-side drive variable speed pulley P1 is smaller than that of the output-side driven variable speed pulley P2 in both the first mode and the second mode of the CVT. In both the first and second modes, the variable speed pulleys function to realize a reducer, so that, although the two modes have the same tension load imposed on the belt B, the moving speed of the belt B is low. Therefore, the CVT in the first and second modes reduces friction heat and gives less damage, which may be caused by both the friction and the shift shock, to the parts, thereby improving durability.

The strongest point of the CVT resides in that the rpm transmission ratio can be continuously changed by changing the diameter ratio between the variable speed pulleys P1 and P2 of the input and output shafts IS and OS in a state in which the discs of the clutch C are engaged with each other, so that the energy loss of the engine E can be minimized. Although the allowable limits for the tension imposed on the belt B and the variable speed pulleys P1 and P2 can endure both the torque load and the high rpm of the input-side drive variable speed pulley P1 having a large diameter in a high stage mode, energy loss and generation of shift shock and friction heat cannot be avoided due to repeated slipping and friction of the belt caused by the high moving speed of the belt B. This damages both the belt and pulleys, and causes related parts to break, thus deteriorating durability and reducing energy efficiency. When the CVT functions as a reduction transmission, the CVT can exhibit advantages due to the intrinsic construction thereof. In a high-speed transmission mode, which corresponds to the 5-stage or 6-stage range of a manual transmission and acts as an acceleration transmission, the CVT has low durability and low energy efficiency compared to a conventional gear transmission in which the teeth directly engage with each other. In other words, the best point of the CVT also acts as its worst point. This is recognized as both bright and seamy sides of the CVT caused by the intrinsic structural characteristics of the CVT. Therefore, the CVT has been mainly used in farming machines, such as farm tractors, which mainly require the function of a reduction transmission, rather than a multi-stage gear transmission having many gears.

Because the techniques of manufacturing the belt B and the variable speed pulleys P1 and P2 have substantially improved in recent years, the belt and the pulleys can efficiently endure a load caused by tension. Therefore, when the dual mode continuously variable transmission (DMCVT) of the present invention is adapted to a car, the DMCVT functions as a reducer, which is the best point of the CVT, and can output high-speed rotation from the drive shaft.

In the dual mode continuously variable transmission (DMCVT) according to the present invention, the variable ratio range, in which the variable speed pulleys are driven, is reduced, so that the size of each variable speed pulley in the DMCVT can be reduced to about half of that of each pulley in the conventional CVT. The reduction in the variable ratio range in the DMCVT realizes an improvement in the transmission performance in addition to reducing the size of the pulleys. Therefore, the manufacturing cost of the DMCVT can be reduced. Further, the DMCVT is free from the high-speed rotation range of the belt, thus realizing improved durability.

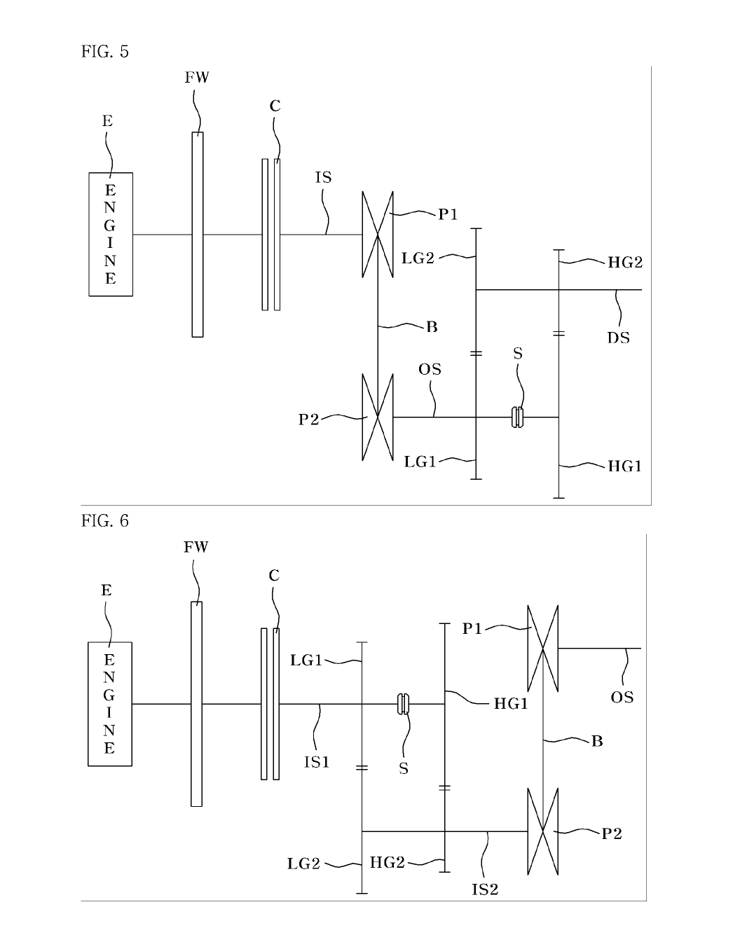

FIG. 5 is a diagram schematically illustrating the construction and power transmission mechanism of a CVT according to a second embodiment of the present invention.

In the second embodiment, the synchro selector S is mounted on the output shaft OS other than the drive shaft DS, and selects gears of either the first mode or the second mode. The mechanism and function of the DMCVT according to the second embodiment except for the above-mentioned difference remains the same as those of the DMCVT according to the first embodiment and further explanation of the mechanism and function of the second embodiment is deemed not necessary.

FIG. 6 is a diagram schematically illustrating the construction and power transmission mechanism of a CVT according to a third embodiment of the present invention. In the third embodiment, gear trains for changing the gear ratios between first and second modes are arranged in front of the variable speed pulleys. Described in detail, a clutch C is mounted to a first input shaft IS1, which is connected to an engine E, with a flywheel FW mounted on a shaft between the engine and the clutch. Further, both a first mode drive gear LG1 and a second mode drive gear HG1 are mounted on a first input shaft IS1 at locations in back of the clutch C. A drive variable speed pulley P1 is mounted on a second input shaft IS2 arranged in parallel to the first input shaft IS1. Further, both a first mode driven gear LG2 and a second mode driven gear HG2, gearing into the first and second mode drive gears LG1 and HG1, respectively, are mounted on a second input shaft IS2 at locations in front of the drive variable speed pulley P1. A driven variable speed pulley P2 mounted on an output shaft OS is coupled to the drive variable speed pulley P1 using a belt B.

Unlike the previous embodiments, in the third embodiment, the output shaft OS functions as a drive shaft for rotating wheels, the gear trains for the first and second modes CVT-1 and CVT-2 having different gear ratios are arranged in front of the two variable speed pulleys P1 and P2. In other words, the gear train for the first mode CVT-1 in which the gear ratio between the drive gear LG1 and the driven gear LG2 is 1:1 and the gear train for the second mode CVT-2 in which the gear ratio between the drive gear HG1 and the driven gear HG2 is 2:1 are arranged at locations between the clutch C and the two variable speed pulleys P1 and P2. The mechanism and function of the DMCVT according to the third embodiment except for the above-mentioned difference in arrangement of parts remains the same as those of the DMCVTs according to the first and second embodiments and further explanation of the mechanism and function of the third embodiment is deemed not necessary.

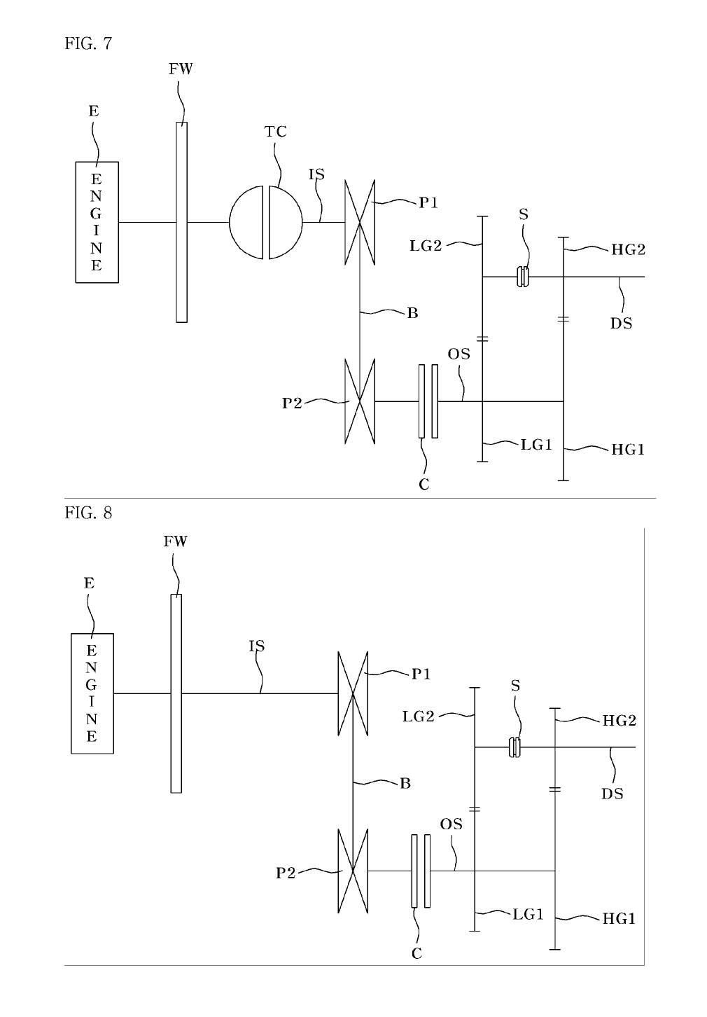

FIG. 7 is a diagram schematically illustrating the construction and power transmission mechanism of a CVT according to a fourth embodiment of the present invention.

Unlike the previous embodiments, in the fourth embodiment, a torque converter TC is mounted on an input shaft IS and a dry type or wet type clutch C is mounted on an output shaft OS. Described in detail, a torque converter TC, which is generally used in automatic transmission, is mounted on the input shaft IS at a location between the flywheel FW and the drive variable speed pulley P1. The dry type or wet type friction clutch C is installed at a location between the driven variable speed pulley P2 and the first mode output gear LG1. This arrangement realizes easy synchronization of rpm between modes during a mode conversion from the first mode CVT-1 to the second mode CVT-2. Described in detail, the torque converter TC is an excellent power control device capable of realizing a soft start of the CVT and effectively preventing the car body from quivering and the engine from suddenly stopping when a car is suddenly stopped. However the torque converter TC is operated using hydraulic pressure and has a slow response velocity due to mechanism and structural characteristics thereof, and thus it is difficult to synchronize the rpm between modes. Accordingly, as shown in FIG. 7, an additional clutch C is installed on the output shaft OS at a location in back of the driven variable speed pulley P2 and controls the transmission of power so as to synchronize the rpms between the first mode and the second mode.

FIG. 8 is a diagram schematically illustrating the construction and power transmission mechanism of a CVT according to a fifth embodiment of the present invention.

In the fifth embodiment, the torque converter TC of the fourth embodiment is removed, but a friction clutch C is installed on the output shaft OS at a location in back of the driven variable speed pulley P2. This arrangement is realized because of the fact that, when the control unit for monitoring the rpm of the engine E, rpm of the input shaft IS, rpm of the output shaft OS and rpm of the drive shaft DS and controlling the variable speed pulleys is improved along with an improvement in the control technique, energy efficiency can be increased by the removal of the torque converter TC from the input shaft IS and by the installation of only the wet type or dry type friction clutch C on the output shaft OS at the location in back of the driven variable speed pulley P2.

In the above-mentioned embodiments, the gear ratios between the gears in the first mode and the second mode are set to 1:1 and 2:1, respectively. However, it should be understood that the gear ratios in respective modes are not limited to 1:1 and 2:1, but may be variously changed as desired. For example, when the gear ratio in the first mode is set to 1:1, the gear ratio in the second mode may be set to within a range of 2˜1:1.

As described above, the present invention provides a dual mode continuously variable transmission (DMCVT) which can be efficiently operated in both low-speed transmission mode and high-speed transmission mode, thus letting stepless transmissions (continuously variable transmissions) be used in middle- and large-sized cars in addition to small-sized cars. Further, when the dual mode continuously variable transmission is used in a hybrid car, which draws attention in recent years, the transmission will realize high utility.

Although preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A dual mode continuously variable transmission comprising:
a drive variable speed pulley mounted on an input shaft connected to an engine;
a driven variable speed pulley mounted on an output shaft arranged in parallel to the input shaft and receiving a rotatory force from the drive variable speed pulley through a belt;
a drive shaft arranged at a location in back of the input shaft such that the drive shaft is in parallel to the output shaft;
a first mode output gear and a second mode output gear mounted on the output shaft;
a first mode drive gear and a second mode drive gear mounted on the drive shaft and gearing into the first mode output gear and the second mode output gear, respectively; and
a synchro selector slidably mounted on at least one of the drive shaft and the output shaft and selectively engaging with gears of the shaft on which the synchro selector is mounted.

2. The dual mode continuously variable transmission according to claim 1, further comprising:
a wet type or dry type friction clutch coupled to the input shaft at a location in front of the drive variable speed pulley, thus controlling power output from the engine.

3. The dual mode continuously variable transmission according to claim 1, wherein a gear ratio between the first mode output gear and the first mode drive gear is different from a gear ratio between the second mode output gear and the second mode drive gear.

4. The dual mode continuously variable transmission according to claim 1, wherein a gear ratio between the first mode output gear and the first mode drive gear is 1:1, and a gear ratio between the second mode output gear and the second mode drive gear is within a range of 2˜1:1.

5. The dual mode continuously variable transmission according to claim 1, further comprising:
a wet type or dry type friction clutch coupled to the output shaft at a location in back of the driven variable speed pulley, thus controlling power output from the input shaft.

6. The dual mode continuously variable transmission according to claim 5, further comprising:
a torque converter coupled to the input shaft at a location in front of the drive variable speed pulley, thus controlling power output from the engine.
